(19) United States
(12) Patent Application Publication
(10) Pub. No.: US 2024/0278538 A1
(43) Pub. Date: Aug. 22, 2024

(54) Glass pane for use in architectural glazing, pane laminates and their use

(71) Applicant: SCHOTT Technical Glass Solutions GmbH, Jena (DE)

(72) Inventors: Sandra von Fintel, Jena (DE); Matthias Schmidt, Jena (DE); Hubert Wieseke, Jena (DE)

(73) Assignee: SCHOTT Technical Glass Solutions GmbH, Jena (DE)

(21) Appl. No.: 18/423,735

(22) Filed: Jan. 26, 2024

Related U.S. Application Data
(60) Provisional application No. 63/482,060, filed on Jan. 30, 2023.

(51) Int. Cl. B32B 17/10

(52) U.S. Cl. CPC B32B 17/10036; B32B 17/10091; B32B 17/10137; B32B 2307/412; B32B 2307/718; B32B 2307/72; B32B 2307/7376

(57) ABSTRACT

The invention relates to a glass sheet, in particular a glass sheet obtained by separation from a preferably floated glass ribbon formed by hot forming, in particular comprising a borosilicate glass, with a length of at least 1.15 m and a width of at least 0.85 m, with a thickness d of at least 0.5 mm, preferably at least 0.7 mm, and at most 7 mm, and uses thereof.

### FIELD OF THE INVENTION

The present application relates to a glass pane for use in architectural glazing and a pane composite and its use.

### Background to the Invention

Glass panes can be used in a variety of applications, for example in vehicle windows, in architectural applications or as covers for electronic devices (so-called display panes).

The international patent application WO 2018/114956 A1 describes a thin glass substrate as well as a method and a device for its production. In the process for producing the thin glass substrate, the viscosity of the glass is specifically adjusted. The international patent application WO 2019/076492 A1 also describes a thin glass substrate, in particular a borosilicate glass thin glass substrate, as well as a method and an apparatus for its manufacture, whereby here too the viscosity of the glass is specifically adjusted in the manufacturing process. Both applications disclose methods for reducing elongated drawing strips produced in the drawing direction during hot forming and indicate measured values transverse to this drawing direction.

The German patent specification DE 10 2007 025 687 B3 describes the use of a glass plate made of borosilicate glass in a flat glass display device and a flat glass display device equipped in this way.

International patent application WO 2022/115280 A1 discloses a glass substrate with improved micro-LED transmission properties, wherein the glass substrate comprises a first major surface, a second major surface opposite the first major surface and a thickness therebetween. An electrically functional layer may be disposed on the first major surface. The glass wafer has a ripple with a magnitude of less than or equal to about one micrometer, in a spatial wavelength range of about 0.25 mm to about 50 mm.

International patent application WO 2021/216362 A1 describes, in general and without detailing the substrates, liquid crystal devices comprising at least two liquid crystal layers, at least one intermediate substrate separating the liquid crystal layers, and at least two alignment layers arranged on opposite surfaces of the intermediate substrate. Also disclosed are liquid crystal windows containing the liquid crystal devices. International patent application WO 2021/222161 A1 describes asymmetric liquid crystal panels, including insulated glazing units and liquid crystal windows incorporating such panels. A thin glass liquid crystal cell is incorporated in an asymmetric thin liquid crystal panel comprising a pane bonded to the first sheet of the liquid crystal cell via an adhesive layer bonding the first sheet to the pane, wherein the liquid crystal material is controllable to adjust a certain light transmittance of the liquid crystal panel.

The US patent application US 2002/012160 A describes glass substrates for display applications.

For architectural applications, such as the glazing of buildings and parts of buildings, great robustness against a wide range of influences is required. Glass, with its mechanical, thermal and chemical resistance, its transmission properties and its resistance to radiation, has an advantage over plastics here.

For applications in architectural glazing, there is a conflict, especially with rather large glass pane formats, between the need for low weight despite the size of the panes and the need for sufficient stability, especially if the pane is to be self-supporting. While the former speaks in favor of the thinnest possible panes, the latter makes a minimum thickness necessary. The conflict of objectives is exacerbated by the fact that compact designs are desired and that for applications such as smart window, switchable window and privacy window applications, high demands are placed on surface properties, in particular on surface fineness. The setting of a sufficiently low surface waviness is highly dependent on the production and hot forming and therefore also on the thickness of the glass. The viscosity curve of the glass required for the respective hot forming results from its composition.

These diverse and sometimes contradictory requirements have not yet been met by state-of-the-art glass panes in a single product.

### Task of the Invention

One task of the invention is therefore to provide a glass pane which reduces the disadvantages of the prior art described above and fulfills the requirements profile described. A further aspect is the use of these glass panes.

### SUMMARY OF THE INVENTION

The problem of the invention is solved by the subject matter of the independent claims. Preferred and specific embodiments can be found in the dependent claims and the description of the present disclosure.

The present invention relates to a glass pane, preferably a glass pane comprising a borosilicate glass or made of a borosilicate glass.
with a length of at least 1.15 m and a width of at least 0.85 m, with a thickness d of at least 0.5 mm, preferably at least 0.7 mm, and at most 7 mm, preferably at most 5 mm, comprising an upper side and a lower side, each of which defines a surface of the glass pane, these surfaces extending essentially parallel to one another.

Instead of the terms top side and bottom side, the terms first side and second side can be used synonymously.

In the case of glass panes produced using the float process, i.e. float glass panes, the surface facing away from the metal bath, i.e. the tin bath, during hot forming in the float process is generally referred to as the top side and the surface of the glass pane facing the tin bath is referred to as the bottom side.

The glass pane according to the invention is particularly suitable for use in architectural glazing.

A key feature of the glass pane according to the invention is its weight per unit area.

Weight per unit area is the ratio of mass to area of a layer or panel. The SI unit for weight per unit area is kg/m². The value is therefore not standardized to a specific thickness, but is only standardized to the area independent of the thickness for one square metre of the respective object. This specification is common for thin products such as paper or cardboard. The weight per unit area is therefore used to compare products that have very similar thicknesses.

For glass panes whose thicknesses can vary over a wide range, such a specification is not helpful. Even within an application area such as architectural glazing, glass with thicknesses of 0.5 mm to 7 mm is used.

Therefore, a “basis weight (dx)” is used in this disclosure for a specified thickness d=x mm.

The glass pane according to the invention has a weight per unit area (d0.7) of at most 1.73. It has a weight per unit area (d1.5) of at most 3.71 and a weight per unit area (d5) of at most 12.36.

The upwardly limited weight per unit area enables greater thicknesses for the same weight than for glass panes with a higher weight per unit area, which means an advantageous increase in stability, or a lower weight for the same thickness, i.e. comparable stability, which is advantageous for the use and handling of the products, particularly during transportation, installation and assembly.

These effects are particularly advantageous when two or more panes are joined together.

Preferably, the glass pane according to the invention has a weight per unit area (d0.7) of at most 1.70 kg/m², preferably of at most 1.62 kg/m², particularly preferably of at most 1.56 kg/m², very particularly preferably of at most 1.53 kg/m²,
a basis weight (d1.5) of at most 3.65 kg/m², preferably of at most 3.47 kg/m² particularly preferably of at most 3.35 kg/m², especially preferably of at most 3.27 kg/m²,
and a basis weight (d5) of at most 12.15 kg/m², preferably of at most 11.55 kg/m², particularly preferably of at most 11.15 kg/m², very particularly preferably of at most 10.90 kg/m².

Preferably, the glass pane according to the invention has a weight per unit area (d0.7) of at least 1.45 kg/m², a weight per unit area (d1.5) of at least 3 kg/m² and a weight per unit area (d5) of at least 10 kg/m².

The glass pane according to the invention has a surface fineness of less than 200 nm on the upper side and/or the lower side.

The surface fine waviness W_{fpd} is measured tactilely in accordance with SEMI D15-1296 “FPD GLASS SUBSTRATE SURFACE WAVINESS MEASUREMENT METHOD” is determined. W_{fpd} is less than 200 nm, preferably less than 150 nm, particularly preferably less than 100 nm, most preferably less than 50 nm, whereby a lower limit of 30 nm is sufficient.

Preferably, the surface fine waviness on the upper side and/or the underside of the glass pane is therefore less than 150 nm, preferably less than 100 nm, particularly preferably less than 50 nm.

The surface waviness and other surface properties are so good that no mechanical surface treatment is required after production.

The surface fine waviness has proven to be significant for the suitability as a spatial delimitation of liquid crystal cells. The surfaces of the top side and/or the bottom side with surface fine waviness according to the invention reduce optical distortions and support compact and thus possibly more cost-effective designs of the glazing.

Preferred thicknesses of the glass pane with a thickness d of at least 0.5 mm and at most 7 mm are in one embodiment more than 2 mm, preferably at least 3.8 mm, particularly preferably at least 4 mm.

This is because with these preferred minimum thicknesses, such glass panes can be used particularly easily as self-supporting panes in glazing and pane assemblies.

In another embodiment of the glass pane with a thickness d of at least 0.5 mm and at most 7 mm, thicknesses d of at most 2 mm are preferred, of at most 1.75 mm particularly preferred and of at most 1.5 mm very particularly preferred. A preferred lower thickness limit is >1 mm.

With such maximum thicknesses mentioned as preferred, they are preferably used in laminates.

Preferred formats of the glass pane with a length of at least 1.15 m and a width of at least 0.85 m are between 2 m×3 m and 3 m×4.2 m. Formats from 2.3 m×3.7 mm to 2.45 m×4.2 or up to 2.45 m×4 m are particularly preferred.

The advantage of weight reduction due to the low specific weight per unit area is particularly noticeable in the larger formats of at least 2 m×3 m.

With the smaller formats mentioned, down to 1.15 m×0.85 m, it is an advantage that a significant increase in stability can be achieved due to the low specific weight per unit area and thus the possible greater equivalent thickness.

In preferred embodiments, the glass pane has a density of less than 2.50 g/cm³, preferably of at most 2.45 g/cm³, preferably of at most 2.40 g/cm³, particularly preferably of less than 2.38 g/cm³, very particularly preferably of at most 2.35 g/cm³ or less than 2.32 g/cm³ or less than 2.25 g/cm³.

A low density helps to achieve the required weight per unit area.

Preferably, the glass pane has a density of at least 2.10 g/cm³.

According to one aspect of the invention, there is provided a glass sheet, in particular a glass sheet obtained by separation from a preferably floated glass ribbon formed by hot molding, in particular comprising a borosilicate glass, having a length of at least 1.5 m and a width of at least 1.8 m, with a thickness d of at least 0.5 mm, preferably at least 0.7 mm, and at most 7 mm, preferably at most 5 mm, comprising a top side and a bottom side, which each define a surface of the glass sheet, these surfaces extending substantially parallel to one another.

The glass panes according to the invention are advantageously suitable for use as glazing, in particular as architectural glazing.

The glass pane according to the invention can be realized by different types of glass, for example by alkali-free alumino(boro)silicate glasses, so-called AF glasses, by (lithium)alumino(boro)silicate glasses, so-called LA(B)S glasses, or by borosilicate glasses.

It is advantageous, especially with regard to the desired low weight, but also the scratch resistance and chemical resistance such as alkali, acid or hydrolytic resistance of the glass pane, if it comprises a borosilicate glass, preferably comprising the following components in % by weight on an oxide basis:

| | |
|---|---|
| SiO₂ | 70 to 87, preferably 75 to 85 |
| B O₂₃ | 5 to 25, preferably 7 to 16 |
| Al O₂₃ | 0 to 6, preferably 1 to 4 |
| Na O₂ | 0.5 to 9, preferably 0.5 to 6.5 |
| K O₂ | 0 to 3, preferably 0.3 to 2.0 |
| CaO | 0 to 3 |
| MgO | 0 to 2. |
| Li O₂ | 0 to 5, preferably up to 0 to 1, particularly preferably 0 to 0.5 |
| R O_{xy} | 0 to 3, preferably >0 to 3, |

where R=Sr, Ba, Zn, Ti, Zr, P, Sn, S, Ce, Fe, Nd and 1≤X≤2; 1≤Y≤5

This type of borosilicate glass has a particularly low density, good scratch resistance and high chemical and thermal resistance.

In this way, it is also possible to obtain glasses with only a low coefficient of thermal expansion. The linear coefficient of thermal expansion in the range between 20° C. and 300° C.(CTE₂₀₋₃₀₀) is preferably 2.5*10⁻⁶/K to 5.5*10⁻⁶/K, but preferably at most 5.0*10⁻⁶/K.

Preferably, the glass sheet comprises a borosilicate glass comprising the following components in % by weight on an oxide basis:

| | |
|---|---|
| SiO₂ | 75 to 80 |
| B O₂₃ | 8 to 12 |
| Al O₂₃ | 2 to 3 |
| Na O₂ | 2 to 3.5 |
| K O₂ | 2 to 3 |
| CaO | 2 to 3 |
| MgO | 1.5 to 2 |
| R O_{xy} | 0 to 3, preferably >0 to 3, |

where R=Sr, Ba, Zn, Ti, Zr, P, Sn, S, Ce, Fe, Nd and 1≤X≤2; 1≤Y≤5

With panes of such compositions, the important property of thermal toughness is particularly advantageous due to particularly high values of Δ(_{CTEliquid}/CTE₂₀₋₃₀₀), i.e. _{CTEliquid}−CTE₂₀₋₃₀₀, of at least 20 ppm/K. _{CTEliquid} denotes the linear thermal expansion coefficient of the glass above the glass transition temperature T_{g}.

It is also preferred if the glass pane comprises a borosilicate glass which comprises the following components in % by weight on an oxide basis:

| | |
|---|---|
| SiO₂ | 80 to 83 |
| B O₂₃ | 12 to 15 |
| Al O₂₃ | 1 to 3 |
| Na O₂ | 1 to 4 |
| K O₂ | 0.5 to 1.5 |
| CaO | 0 to 0.5, preferably >0 to 0.5 |
| MgO | 0 to 0.5, preferably >0 to 0.5 |
| Li O₂ | 0 to 0.5, preferably >0 to 0.5 |
| R O_{xy} | 0 to 3, preferably >0 to 3, |

where R=Sr, Ba, Zn, Ti, Zr, P, Sn, S, Ce, Fe, Nd and 1≤X≤2; 1≤Y≤5

The important property of density is particularly advantageous for panes of such compositions due to particularly low values of less than 2.25 g/cm³, in particular no more than 2.22 g/cm³.

In particular, when the panes are used in switchable windows, it is advantageous, namely for the longevity of the switchable windows due to the avoidance of alkali migration, if the glass pane comprises an AF glass, which preferably comprises the following components in % by weight on an oxide basis:

| | |
|---|---|
| SiO₂ | 55 to 65 |
| B O₂₃ | 5 to 15 |
| Al O₂₃ | 15 to 20 |
| CaO | 0 to 5, preferably >0 to 5 |
| MgO | 0 to 3, preferably >0 to 3 |
| R O_{xy} | 0 to 3, preferably >0 to 3, |

where R=Sr, Ba, Zn, Ti, Zr, P, Sn, S, Ce, Fe, Nd and 1≤X≤2; 1≤Y≤5

For chemically toughened glass panes and pane laminates in particular, it is advantageous if the glass pane comprises an (L)A(B)S glass, which preferably comprises the following components in % by weight on an oxide basis:

| | |
|---|---|
| SiO₂ | 60 to 70 |
| B O₂₃ | 3 to 5 |
| Al O₂₃ | 15 to 20 |
| Li O₂ | 3 to 5 |
| Na O₂ | 1 to 5 |
| K O₂ | 0 to 1 |
| CaO | 0 to 5, preferably >0 to 5 |
| MgO | 0 to 2, preferably >0 to 2 |
| R O_{xy} | 0 to 3, preferably >0 to 3, |

where R=Sr, Ba, Zn, Ti, Zr, P, Sn, S, Ce, Fe, Nd and 1≤X≤2; 1≤Y≤5

In particular, when the glass pane according to the invention is not used as a self-supporting pane but in a laminate, it can be combined with various materials, for example laminated with a soda-lime-silicate glass, an aluminum silicate glass, an alkali aluminosilicate glass, an alkali borosilicate glass, an alkali aluminophosphosilicate glass, an alkali aluminoborosilicate glass or combinations thereof, bonded with a polymer film, e.g. PVB, EVA or TPU.

The laminate can be made of identical glass panes or of different glass panes, but with matching expansion coefficients, or of glass and plastic panes with matching expansion coefficients.

In one embodiment, the glass pane has a light transmission Y (D65.2°) of at least 91%, preferably at least 93%. Preferably, this minimum value is based on a glass pane with a thickness of 5 mm. The high transparency particularly ensures that it provides an excellent and undisturbed view for a wide variety of applications in architectural glazing.

The designations light transmission and brightness Y correspond to the same measured variable, measured according to DIN 5033 in the CIE color system as Y(D65), 2°).

In one embodiment, the glass pane has a transmission T_{@850 nm} of at least 91%, preferably at least 93%, at a wavelength of 850 nm, measured with standard light C, 2° on a fire-polished sample. Preferably, this minimum value is related to a glass pane with a thickness of 5 mm.

The low absorption in the near IR range ensures that a high degree of efficiency is achieved in glazing with energy-generating windows. Particularly in systems in which the glass pane acts as a waveguide to guide the photons to the external solar cells, a significant increase in energy yield is possible.

One criterion for the aforementioned robustness of the glass pane according to the invention is the temperature quenching resistance (ASF). At 3.8 mm, it has a temperature quenching resistance (ASF) of at least 170 K (5% fractile), preferably at least 175 K (5% fractile).

The temperature quenching strength (ASF) is determined as follows:

Test panes of approx. 20×20 cm² are heated to test temperature in an oven and then cooled with 50 ml of 20° C. cold water (room temperature) in the center of the pane. The temperature is measured without contact using a pyrometer. The ASF value is the temperature difference between the hot disk and the cold water. ≤5% of the test panes may fail due to breakage. To simulate the surface condition during practical use, the test discs are treated with SIC 220 grit sandpaper before the test.

One criterion for the aforementioned robustness of the glass pane according to the invention is the temperature gradient strength (TGF). For example, at 3.8 mm it has a temperature gradient strength (TGF) of at least 110 K (T_{zug}) (5% fractile) and/or at least 120 K (T_{heiz}) (5% fractile).

The temperature gradient strength (TGF) is determined as follows:

Test panes measuring approx. 25×25 cm² are heated to a specific temperature in the area of the center of the surface by means of programmed control; the edge of the pane is kept at room temperature. In a test time of less than one minute, the temperature rises until breakage occurs. The temperature is measured without contact using a pyrometer and is recorded automatically. The TGF value indicates the temperature difference between the hot center of the pane and the cold edge of the pane. Here, ≤5% of the samples may fail due to thermal stress fracture. In order to simulate the surface condition during practical use, the test panes are machine-treated with SIC 220 grit sandpaper before the test.

T_{zug} stands for sudden temperature supply, T_{heiz} for continuous heating.

A high temperature gradient resistance is particularly advantageous when temperature differences occur in a glazing unit, for example due to partial shading of the glass pane or the pane assembly by other buildings or trees.

Advantageously, the glass pane according to the invention can be produced with said low surface fineness in a process for producing a glass pane, in particular a process for continuously producing a glass pane comprising the steps of
Providing a batch comprising glass raw materials,
Melting the batch to obtain a molten glass,
Adjusting the viscosity of the molten glass,
Transferring the molten glass to a device for hot forming, in particular by means of floating to form a glass ribbon,
Separation of the hot-formed glass ribbon while retaining a glass pane.

According to one embodiment, the glass pane is particularly preferably designed as a float glass pane. In this way, a low surface waviness can be provided on at least one surface of one side of the glass pane.

The float process is mentioned as an example of the process used to manufacture the glass pane according to the invention, but the manufacture is not limited to such a process.

The details of the float process and the systems for float processes are known to those skilled in the art. For example, DE 10 2007 025 687 B3 and US 2002/012160 A already describe float processes and their products. The latter publication also describes how the waviness of the product is influenced by the thickness of the product to be thermoformed and the float conditions.

The invention has made it possible to achieve a product with a sufficient surface quality, in particular a low surface waviness, directly during the hot forming of a glass sheet, without the need for subsequent mechanical surface treatment of the glass sheet.

Thus, the data given for the embodiment examples refer to hot-formed glass sheets after they have been separated, but which have not been subjected to surface treatment in addition to hot forming, either during hot forming or after hot forming.

The general term surface treatment includes both the aforementioned mechanical and chemical or thermal treatment of the surface, which is particularly suitable for smoothing the surface or reducing elevations and depressions on it, as well as methods for generating compressive and/or tensile stresses which are suitable for increasing the strength of the machined surface, such as thermal or chemical prestressing.

However, in certain embodiments, for example for fire-resistant glazing, it may be of interest to subject the glass pane to the process of chemical or thermal toughening.

A borosilicate glass sheet, especially with the preferred composition ranges mentioned, is particularly suitable for chemical toughening. Its alkali content is sufficiently high to generate adequate toughening.

However, it is also sufficiently low to keep alkali migration to a minimum, which is essential when using the panes in switchable windows. This is reflected in a significant increase in the service life of the Smart Window.

With regard to the different thicknesses, the expert knows how to adapt the prestressing processes, especially the temperature-time profile for thermal prestressing. For example, a much narrower process window exists for thinner thicknesses.

### EXAMPLES

In the table, examples of design examples (designation starting with A) and a comparative example (designation starting with V) are given.

The table contains the composition of the examples in % by weight on an oxide basis. The “remainder” comprises components not previously mentioned, in particular RxOy, where R=Sr, Ba, Zn, Ti, Zr, P, Sn, S, Ce, Fe, Nd and 1≤ X≤2 1≤Y≤5.

The table also contains the following properties of the examples:
the density ρ in g/cm³,
the coefficient of expansion CTE₂₀₋₃₀₀ in 10/K,⁻⁶
the coefficient of expansion CTEliquid in 10/K⁻⁶
and the difference _{CTEliquid}−CTE₂₀₋₃₀₀ in 10⁻⁶/K,
the light transmission Y (D65.2°) in %, measured according to DIN 5033 in the CIE color system on a sample with a thickness of 5 mm or on the pane with the thickness of the respective example,
the transmission T at a wavelength of 850 nm, measured with standard light C, 2º on a fire-polished sample with a thickness of 5 mm or on the disk with the thickness of the respective example,
Length, width and thickness of the pane,
the “Weight per unit area (dx)” for the thicknesses 0.7 mm (d0.7), 1.5 mm (d1.5) and 5 mm (d5) in kg/m², whereby to determine the respective weight per unit area, a pane of the corresponding thickness in the format 50×50 cm was weighed and the result converted to 1 m. To determine the respective basis weight, a sheet of the corresponding thickness in the format 50×50 cm² was weighed and the result was converted to 1 m² or the sheet of a different thickness, namely the thickness specified in the table, was used and the result was converted to the thickness considered according to (d0.7), (d1.5) and (d5);
the surface fine waviness W_{fpd} in nm, the length in mm over which the measurement was taken, the thickness in mm at which the measurement was taken;
the temperature quenching strength ASF in K (5% fractile) for samples with the specified thickness;
the temperature gradient strength TGF in K (5% fractile) for samples with the specified thickness, both with sudden temperature application (T_{zug}) and with continuous heating (T_{heiz}).

TABLE 1

| Addition | | | | | | | | | |
|---|---|---|---|---|---|---|---|---|---|
| [% by weight] | A1 | A2 | A3 | A4 | A5 | A6 | A7 | A8 | V1 |
| SiO₂ | 72 | 82 | 81 | 81 | 78 | 67 | 67 | 62 | 72 |
| B O₂₃ | 25 | 15 | 15 | 13 | 10 | 4 | 10 | — | — |
| Al O₂₃ | 1 | 1 | 1 | 2 | 3 | 17 | 11 | 16 | — |
| Li O₂ | — | — | — | — | — | 4 | — | — | — |
| Na O₂ | 1 | 1 | 3 | 4 | 3 | 2 | — | 12 | 14 |
| K O₂ | 1 | 1 | — | 1 | 3 | — | — | 4 | — |
| MgO | — | — | — | — | 2 | 1 | 5 | 4 | 3 |
| CaO | — | — | — | — | 3 | 3 | 6 | — | 10 |
| Rest | 0 | 0 | 0 | 0 | 0 | 2 | 1 | 1 | 0 |
| Total | 100 | 100 | 100 | 100 | 100 | 100 | 100 | 100 | 100 |
| Density | 2.13 | 2.17 | 2.18 | 2.22 | 2.31 | 2.39 | 2.43 | 2.46 | 2.50 |
| [g/cm]³ | | | | | | | | | |
| CTE₂₀₋₃₀₀ | 3.29 | 2.57 | 2.77 | 3.25 | 4.15 | 5.5 | 3.15 | 8.7 | 9 |
| [10⁻⁶/K] | | | | | | | | | |
| _{CTEliquid} | 4.1 | | | 9.7 | 26.7 | | | | |
| [10⁻⁶/K] | | | | | | | | | |
| _{CTEliquid} − | 1.97 | | | 6.45 | 22.55 | | | | |
| CTE₂₀₋₃₀₀ | | | | | | | | | |
| [10⁻⁶/K] | | | | | | | | | |
| Y (D65.2°) | 93 | | | 93 | 92 | | | | 91 |
| [%] (for | (5.02) | | | (4.91) | (5.00) | | | | (4.89) |
| d = . . . mm) | | | | | | | | | |
| T 850 nm | 93 | | | 93 | 92 | | | | 84 |
| [%] (at | (5.02) | | | (4.91) | (5.00) | | | | (4.89) |
| d = . . . mm) | | | | | | | | | |
| W_{fpd} [nm] | | | | 38 | 32 | 85 | | 68 | 58 |
| Meas. | | | | 20 | 20 | 20 | | 20 | 20 |
| length [mm] | | | | | | | | | |
| Gem. with a | | | | 2.25 | 6 | 0.7 | | 0.7 | 0.7 |
| thickness d | | | | | _{(thermally} | | | | |
| [mm] | | | | | _{prestressed)} | | | | |
| ASF [K] | | | | 192 | >350 | | | | 30 |
| 5% fractile | | | | (3.8) | (5) | | | | (4) |
| (at | | | | | _{(thermally} | | | | |
| d = . . . mm) | | | | | _{prestressed)} | | | | |
| TGF: T_{heiz} | | | | 123 | >350 | | | | 40 |
| [K] 5% | | | | (3.8) | (5) | | | | (4) |
| fractile (at | | | | | _{(thermally} | | | | |
| d = . . . mm) | | | | | _{prestressed)} | | | | |

The examples illustrate very clearly that the choice of glass leads to different surface weights, which can be used for thicker and therefore more stable products with the same weight (see Table 2) or for lighter products with the same thickness (see Table 3).

TABLE 2

| | A1 | A2 | A3 | A4 | A5 | A6 | A7 | A8 | V1 |
|---|---|---|---|---|---|---|---|---|---|
| Density [g/cm³] | 2.13 | 2.17 | 2.18 | 2.23 | 2.31 | 2.39 | 2.43 | 2.46 | 2.5 |
| Thickness [mm] | Weight per unit area kg/m² | | | | | | | | |
| 0.7 | 1.49 | 1.52 | 1.53 | 1.56 | 1.62 | 1.67 | 1.70 | 1.72 | 1.75 |
| 1.5 | 3.20 | 3.26 | 3.27 | 3.35 | 3.47 | 3.59 | 3.65 | 3.69 | 3.75 |
| 5 | 10.65 | 10.85 | 10.90 | 11.15 | 11.55 | 11.95 | 12.15 | 12.30 | 12.50 |
| | Possible thickness with basis weight of V1 [mm] −> Stability gain compared to V1 | | | | | | | | |
| | 0.82 | 0.81 | 0.80 | 0.78 | 0.76 | 0.73 | 0.72 | 0.71 | 0.70 |
| | 1.76 | 1.73 | 1.72 | 1.68 | 1.62 | 1.57 | 1.54 | 1.52 | 1.50 |
| | 5.87 | 5.76 | 5.73 | 5.61 | 5.41 | 5.23 | 5.14 | 5.08 | 5.00 |

TABLE 3

| | A1 | A2 | A3 | A4 | A5 | A6 | A7 | A8 | V1 |
|---|---|---|---|---|---|---|---|---|---|
| Density [g/cm³] | 2.13 | 2.17 | 2.18 | 2.23 | 2.31 | 2.39 | 2.43 | 2.46 | 2.5 |
| Thickness [mm] | Weight per unit area kg/m² | | | | | | | | |
| 0.7 | 1.49 | 1.52 | 1.53 | 1.56 | 1.62 | 1.67 | 1.70 | 1.72 | 1.75 |
| 1.5 | 3.20 | 3.26 | 3.27 | 3.35 | 3.47 | 3.59 | 3.65 | 3.69 | 3.75 |
| 5 | 10.65 | 10.85 | 10.90 | 11.15 | 11.55 | 11.95 | 12.15 | 12.30 | 12.50 |
| | Weight saving compared to V1 [%] with the same thickness (i.e. comparable stability) | | | | | | | | |
| | 14.80% | 13.20% | 12.80% | 10.80% | 7.60% | 4.40% | 2.80% | 1.60% | |

In one embodiment of the invention, at least two glass panes, of which at least one glass pane according to the invention, preferably at least two glass panes according to the invention, form a pane composite.

Such a pane laminate can consist of two glass panes that are connected via spacers, for example so-called warm-edge spacers, and one or more sealants.

Such a pane assembly can also consist of more than two panes of glass, for example with a central third pane.

The pane composite with at least one glass pane according to the invention can also be laminated from glass panes, films and/or other materials, whereby the panes, the films and/or the other materials can be applied to a monolithic pane or a pane composite.

The glass panes of the pane laminate can have different compositions and/or different thicknesses and/or different surface wavinesses on their upper and/or lower sides. The glass panes of the pane laminate can also have the same composition and/or the same thickness and/or the same surface waviness.

One advantage of using a pane according to the invention, in particular a glass pane with the same composition, for both the front and the back of a display device or smart window is that it eliminates potential problems that can arise from different thermal expansion coefficients of the front and back glass.

The panes of the pane laminate can be coated, for example with a TCO coating on the inside of the space formed by the laminate.

The basis weight of the laminate is the sum of the basis weights of the individual panes and connecting films:

$${grammage}_{Verbund} = {δ}_{1} * {d}_{1} + … + {δ}_{n} * {d}_{n}$$

In one embodiment of the invention, the glass pane or pane composite according to the invention is used in glazing, in particular in architectural glazing of buildings, for smart window, switchable window, privacy window applications, in particular in “suspended particle devices” (so-called SPD), or having electrochromic layers, or for liquid crystal units, including so-called PDLC(=“particle dispersed liquid crystal”).

The technical term “smart windows” refers to “intelligent” or “thinking” windows—namely windows with glazing that can change their properties according to the user's needs. Transparency, translucency, color and reflectivity can be reversibly adjusted depending on environmental influences such as direct sunlight. Many of these switchable and adjustable glazings are based on the use of liquid crystals in the space between the panes, i.e. in the space formed by the pane composite.

Energy-saving windows use solar radiation to generate electricity. Switchable windows provide solar shading and help to reduce energy costs and CO emissions.₂

Privacy windows, which instantly change from transparent to translucent, make blinds in buildings superfluous and provide more privacy.

Darkening and heat-insulating systems are preferably implemented using electrochromic devices or “suspended particle devices”. They change from transparent to dark when in use, thus keeping the sun out of the interior of the building and helping to reduce energy costs. Liquid crystal solutions, on the other hand, are used more as privacy windows. They change from transparent to white.

In one embodiment of the invention, the glass pane or pane composite according to the invention is used in glazing, in particular architectural glazing of buildings for energy generation by transparent solar windows. In a further embodiment of the invention, the glass pane or pane composite according to the invention is used in glazing, in particular architectural glazing, as a combination, e.g. by using the energy of the solar windows to operate switchable windows.

In one embodiment of the invention, the glass pane or the pane composite according to the invention is used in glazing, in particular in architectural glazing of buildings, in particular for liquid crystal units, for smart window, switchable window, privacy window applications, in such a way that at least the side of the glass pane or the glass panes facing the liquid crystal unit has a surface fine wavelength of less than 200 nm, preferably less than 150 nm, particularly preferably less than 100 nm, very particularly preferably less than 50 nm.

Thus, one advantage of the invention, namely the good surface fine waviness, is particularly effective, as it reduces optical distortions and supports compact and thus possibly more cost-effective designs of the glazing.

In one embodiment of the invention, the glass pane according to the invention or at least one glass pane of the pane laminate is a float glass pane, preferably made of alkali-containing borosilicate glass, and the glass pane according to the invention or the pane laminate is used in glazing, in particular in architectural glazing of buildings, in particular for liquid crystal units, for smart window, switchable window, privacy window applications, and also for TFT-LCD and electrochromic devices in such a way that the side of the glass pane or panes facing the atmospheric side of the float bath during the float process faces the liquid crystal unit.

Thus, an advantage of this preferred embodiment comes into play, which is based on the fact that in a floated alkali-containing glass, in particular a borosilicate glass, the side of the glass that comes into contact with the bath metal (usually tin) and the side of the glass that comes into contact with the atmosphere above the float bath (atmosphere side) have a different diffusion behavior with regard to the alkali ions. The alkali ions on the atmosphere side of the glass diffuse from the surface only to such a small extent that such a glass plate can be used as a pane in a flat display device or as a substrate for thin-film PV cells without any further post-treatment to reduce the alkali ion content in the surface if it is installed in such a way that its atmosphere side faces the electrically excitable optically active layer. Depending on the end application, no passivation layers are required.

The structure of a TFT-LCD flat panel display with at least one float glass panel according to the invention is described below as an example. The front panel is formed by a glass plate generally referred to as a color filter plate. At least this is a glass pane according to the invention. The rear end of the screen is formed by the glass pane known as the back plate. It can also be designed as a glass pane according to the invention. The liquid crystal layer is located between the front pane (color filter plate) and the back plate. The exact distance between the two panes is ensured by spacers. Preferably, at least the front pane is arranged in the display in such a way that the side facing inwards towards the liquid crystal layer has a surface fine wavelength of less than 200 nm.

Preferably, at least the front pane is a float glass pane and is arranged in the display in such a way that its surface which came into contact with the tin bath during manufacture according to the float process faces outwards, while the atmospheric side of the pane which came into contact with the atmosphere above the float bath during manufacture faces inwards towards the liquid crystal layer.

The front screen and back plate are provided with polarizer layers on their outer sides. The front screen has a black matrix on its underside, a color filter layer for the colors red, green and blue and a transparent common electrode, which usually consists of an ITO layer. The back plate carries a thin-film transistor that drives a pixel electrode. An alignment layer is also arranged on the front screen and the back plate. The display is sealed towards the edge by means of a gasket. The common electrode of the front panel is electrically connected to the common electrode of the back plate by means of the connector (short). If the pixel electrode is controlled by the TFT transistor, the liquid crystals of the relevant pixel in the liquid crystal layer rotate and the relevant pixel is activated.

The glass panes, pane laminates and glazing described can also be components of systems such as those known for fire-resistant glazing.

It is understood that the advantages of the invention described in the embodiment examples for individual panes are particularly effective for pane assemblies.

1. Glass pane with a length of at least 1.15 m and a width of at least 0.85 m, with a thickness d of at least 0.5 mm, comprising a top side and a bottom side, characterized by a surface fineness on the top side and/or the bottom side of less than 200 nm and by a weight per unit area (d0.7) of at most 1.73 kg/m², a weight per unit area (d1.5) of at most 3.71 kg/m² and a weight per unit area (d5) of at most 12.36 kg/m².

2. Glass pane according to claim 1, characterized in that the surface fine waviness on the upper side and/or the lower side is less than 150 nm.

3. Glass pane according to claim 1, characterized by a thickness d of more than 2 mm.

4. Glass pane according to claim 1, characterized by a thickness d of at most 2 mm.

5. Glass pane according to claim 1, characterized by a basis weight (d0.7) of at least 1.45 kg/m², a basis weight (d1.5) of at least 3 kg/m² and a basis weight (d5) of at least 10 kg/m².

6. Glass pane according to claim 1, characterized in that it has a light transmission Y) (D65.2°), measured at a thickness d=5 mm, of at least 91%.

7. Glass pane according to claim 1, characterized in that, measured at a thickness d=5 mm, it has a transmission of at least 91% at the wavelength 850 nm.

8. Glass pane according to claim 1, characterized by a density of less than 2.50 g/cm³.

9. Glass pane according to claim 1, characterized by a density of at least 2.10 g/cm³.

10. Glass pane according to claim 1, comprising a borosilicate glass, preferably comprising the following components in % by weight:

| | |
|---|---|
| SiO₂ | 70 to 87 |
| B₂O₃ | 5 to 25 |
| Al₂O₃ | 0 to 6 |
| Na₂O | 0.5 to 9 |
| K₂O | 0 to 3 |
| CaO | 0 to 3 |
| MgO | 0 to 2. |
| Li₂O | 0 to 5 |
| RₓO_{y} | 0 to 3, |

where R=Sr, Ba, Zn, Ti, Zr, P, Sn, S, Ce, Fe, Nd and 1≤X≤2; 1≤Y≤5.

11. Glass pane according to claim 10, characterized in that at 3.8 mm it has a temperature quenching strength (ASF) of at least 170 K (5% fractile), preferably at least 175 K (5% fractile).

12. Glass pane according to claim 10, characterized in that it has a temperature gradient strength (TGF) of at least 110 K (T_{zug}) and/or at least 120 K (T_{heiz}) at 3.8 mm.

13. Glass pane according to claim 10, characterized in that it is chemically or thermally toughened.

14. Glass pane according to claim 10, wherein the glass pane is a float glass pane.

15. Pane composite comprising at least two glass panes, of which at least one is the glass pane of claim 1.

16. A glazing comprising the glass pane of claim 15.

17. The glazing according to claim 16, wherein at least a side of the glass pane facing a liquid crystal unit has a surface fine wavelength of less than 200 nm.

18. The glazing according to claim 16, wherein a side of the glass pane facing an atmospheric side of the float bath during a float process faces a liquid crystal unit.
